(19) United States
(12) Patent Application Publication
(10) Pub. No.: US 2020/0128319 A1
(43) Pub. Date: Apr. 23, 2020

(54) SPEAKER APPARATUS

(71) Applicant: LUXSHARE-ICT CO., LTD., Taipei City (TW)

(72) Inventors: Kuan-Chun Liao, Taipei City (TW); Chun-Yuan Chen, Taipei City (TW); Chih-Chiang Cheng, Taipei City (TW); Chiao-Fan Huang, Taipei City (TW)

(73) Assignee: LUXSHARE-ICT CO., LTD., Taipei City (TW)

(21) Appl. No.: 16/357,707

(22) Filed: Mar. 19, 2019

(30) Foreign Application Priority Data
Oct. 18, 2018 (TW) 107136833

(51) Int. Cl. H04R 1/28; H04R 9/04; H04R 9/06

(52) U.S. Cl. CPC H04R 1/2819; H04R 1/2834; H04R 2400/11; H04R 9/06; H04R 9/04

(57) ABSTRACT

A speaker apparatus includes an enclosure, a speaker unit, and a bass reinforcement unit. The enclosure includes an inner cavity, where a cavity volume of the inner cavity is in a range of 0.5 milliliter to 1 milliliter, the enclosure has a cavity acoustic compliance value, and the cavity acoustic compliance value is obtained by dividing the cavity volume by a product of air density and a sound velocity squared. The speaker unit includes a diaphragm and a surround, the speaker unit has a speaker acoustic compliance value and an effective sound outlet area, and the speaker acoustic compliance value is a product of a mechanical compliance value of the surround and the effective sound outlet area squared, and a ratio of the speaker acoustic compliance value to the cavity acoustic compliance value is less than or equal to 1. The bass reinforcement unit outputs a low-frequency response frequency.

### CROSS-REFERENCE TO RELATED APPLICATION

This non-provisional application claims priority under 35 U.S.C. § 119(a) to Patent Application No. 107136833 filed in Taiwan, R.O.C. on Oct. 18, 2018, the entire contents of which are hereby incorporated by reference.

### BACKGROUND

### Technical Field

The present disclosure relates to an audio playback apparatus, and in particular, to a speaker apparatus.

### Related Art

Speakers (or referred to as loudspeakers) are very common sound playback apparatuses at present. A function of a speaker is converting electrical signals into mechanical vibrations of a diaphragm, to further generate changes in compression and rarefaction of surrounding air to generate sound for people nearby to listen.

For some large speakers, to reinforce sound pressure in a low-frequency band, a bass reinforcement apparatus, such as a bass reflex tube or a passive radiator, is usually added into an enclosure, to produce a low frequency reinforcing effect by using a characteristic of phase reversal.

As current electronic apparatuses are developed to be lighter and thinner, because many electronic apparatuses (such as smartphones, tablet computers, or notebook computers) have small internal spaces, micro speakers are used in most of them to reduce occupied volumes and thicknesses. However, because enclosures of micro speakers have very small volumes (most below 1 milliliter), if a bass reinforcement apparatus is introduced, not only a low frequency reinforcement effect cannot be normally produced, but also original output performance of the speakers would be degraded.

### SUMMARY

In view of the above, in an embodiment, a speaker apparatus is provided. The speaker apparatus includes an enclosure, a speaker unit, and a bass reinforcement unit. The enclosure includes an inner cavity, where a cavity volume of the inner cavity is in a range of 0.5 milliliter to 1 milliliter, the enclosure has a cavity acoustic compliance value, and the cavity acoustic compliance value is obtained by dividing the cavity volume by a product of air density and a sound velocity squared. The speaker unit is disposed inside the inner cavity, where the speaker unit includes a diaphragm and a surround, the surround is disposed around the diaphragm in a surrounding manner, the speaker unit has a speaker acoustic compliance value and an effective sound outlet area, and the speaker acoustic compliance value is a product of a mechanical compliance value of the surround and the effective sound outlet area squared, where the effective sound outlet area is proportional to an area of the diaphragm, and a ratio of the speaker acoustic compliance value to the cavity acoustic compliance value is less than or equal to 1. The bass reinforcement unit is disposed inside the inner cavity, where the bass reinforcement unit outputs a low-frequency response frequency according to operation of the speaker unit.

In conclusion, in the speaker apparatus of the embodiments of the instant disclosure, the ratio of the speaker acoustic compliance value to the cavity acoustic compliance value is adjusted to be less than or equal to 1, so as to ensure that the bass reinforcement unit can increase sound pressure in a low-frequency band and reinforce output performance of the speaker apparatus when the bass reinforcement unit is introduced into the enclosure having a relatively small inner cavity (for example, an inner cavity whose cavity volume is in a range of 0.5 milliliter to 1 milliliter).

### BRIEF DESCRIPTION OF THE DRAWINGS

FIG. 1 is a schematic diagram of application of an embodiment of a speaker apparatus according to the instant disclosure;

FIG. 2 is a three-dimensional exploded diagram of an embodiment of a speaker apparatus according to the instant disclosure;

FIG. 3 is a cross-sectional view of an embodiment of a speaker apparatus according to the instant disclosure;

FIG. 4 is an internal schematic diagram of an embodiment of a speaker apparatus according to the instant disclosure;

FIG. 5 is an internal schematic diagram of another embodiment of a speaker apparatus according to the instant disclosure;

FIG. 6 is a diagram of a sound pressure-frequency curve of an embodiment of a speaker apparatus according to the instant disclosure;

FIG. 7 is a cross-sectional view of an embodiment of a speaker unit according to the instant disclosure;

FIG. 8 is a partial enlarged diagram of FIG. 7;

FIG. 9 is a schematic diagram of a voice coil of an embodiment of a speaker unit according to the instant disclosure; and

FIG. 10 is a schematic diagram of a circuit of an embodiment of a speaker unit according to the instant disclosure.

### DETAILED DESCRIPTION

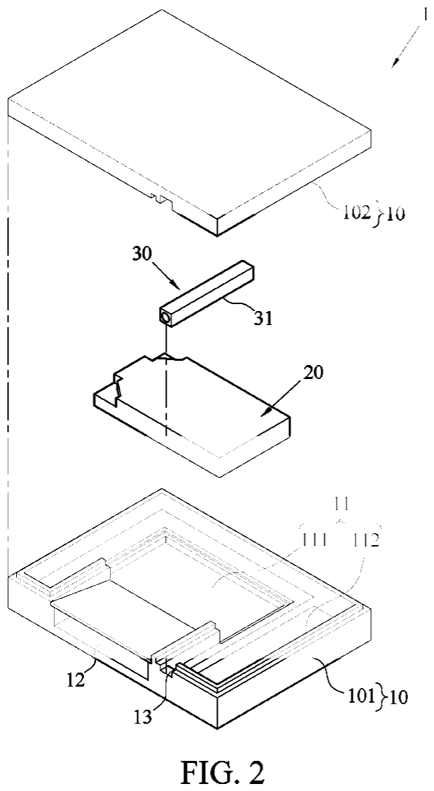

FIG. 1 is a schematic diagram of application of an embodiment of a speaker apparatus according to the instant disclosure, and FIG. 2 is a three-dimensional exploded diagram of an embodiment of a speaker apparatus according to the instant disclosure. As shown in FIG. 1 and FIG. 2, a speaker apparatus 1 of this embodiment includes an enclosure 10, a speaker unit 20, and a bass reinforcement unit 30. The speaker unit 20 and the bass reinforcement unit 30 are disposed inside the enclosure 10. In an embodiment, the speaker apparatus 1 may be a micro speaker, so as to be applied to a thin or small electronic product (for example, a smartphone, a tablet computer, or a notebook computer) having a relatively small inner space. As shown in FIG. 1, in this embodiment, the speaker apparatus 1 is disposed inside a smartphone 2, to generate sound for people nearby to listen. However, no limitation is imposed in this embodiment.

As shown in FIG. 2, in this embodiment, the enclosure 10 includes an inner cavity 11. In this embodiment, the inner cavity 11 includes a first cavity 111 and a second cavity 112. That is, the inner cavity 11 is further divided into two cavities. The first cavity 111 has a first sound outlet 12, and the second cavity 112 has a second sound outlet 13. The first sound outlet 12 and the second sound outlet 13 are arranged on a same side of the enclosure 10. However, no limitation is imposed herein. The first sound outlet 12 and the second sound outlet 13 may alternatively be arranged on different sides of the enclosure 10. In addition, in this embodiment, the enclosure 10 includes a hollow base 101 and a cover body 102. In a manufacturing process, the speaker unit 20 and the bass reinforcement unit 30 may be first mounted into the hollow base 101 separately, and the cover body 102 is fixed onto the hollow base 101 in a covering manner, so that the speaker unit 20 and the bass reinforcement unit 30 are respectively fixed in the first cavity 111 and the second cavity 112.

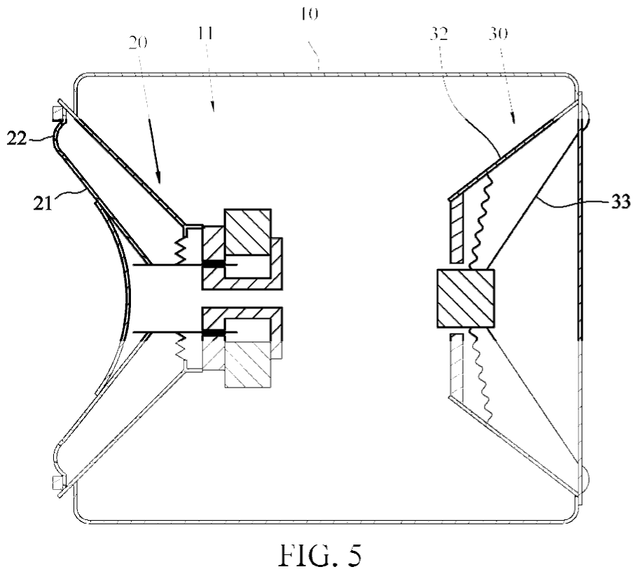

As shown in FIG. 2 and FIG. 3, a cavity volume V of the inner cavity 11 of the enclosure 10 of this embodiment is in a range of 0.5 milliliter to 1 milliliter, so that the instant disclosure is applicable to a thin or small electronic product having a relatively small inner space. In some embodiments, the cavity volume V may be a net volume of the second cavity 112 of the inner cavity 11, that is, a volume excluding other components (such as the bass reinforcement unit 30) inside the second cavity 112.

Further, the enclosure 10 has a cavity acoustic compliance value Cab. The cavity acoustic compliance value Cab is obtained by dividing the cavity volume V by a product of air density p and a sound velocity c squared. That is, a calculation formula of the cavity acoustic compliance value Cab is Cab=V/ρc², where V is the cavity volume of the inner cavity 11, ρ is the air density (approximately, 1.29 kg/m³), and c is the sound velocity (approximately, 343 m/s). It can be learned from the foregoing calculation formula that the cavity acoustic compliance value Cab and the cavity volume V are positively correlated to each other. In other words, a smaller cavity volume V indicates a smaller cavity acoustic compliance value Cab of the enclosure 10.

As shown in FIG. 2 and FIG. 3, the speaker unit 20 corresponds to the first sound outlet 12 of the enclosure 10 and may be fixed in the enclosure 10 in a manner such as a gluing, locking, or clamping manner. In this embodiment, the speaker unit 20 faces an interior of the first cavity 111 instead of directly facing the first sound outlet 12. However, no limitation is imposed herein. In another embodiment, as shown in FIG. 4, the speaker unit 20 may alternatively directly face the first sound outlet 12, to enable the first sound outlet 12 to output sound. As shown in FIG. 4, in an embodiment, the speaker unit 20 may be a moving-coil speaker and includes a diaphragm 21, a surround 22, a magnetic body 23, a voice coil 24, a support 25, and a yoke 26. The magnetic body 23 is made of magnetically permeable material and is combined with the yoke 26. The yoke 26 has an annular magnetic gap G. The voice coil 24 is disposed inside the magnetic gap G of the yoke 26 in a winding manner and is adjacent to the magnetic body 23. In addition, the voice coil 24 is not in contact with the yoke 26 and is connected to the diaphragm 21, so that when the voice coil 24 moves, the voice coil 24 can actuate the diaphragm 21 to vibrate synchronously. The surround 22 is disposed around the diaphragm 21 in a surrounding manner and is connected between the diaphragm 21 and the support 25. Hence, when a current passes through the voice coil 24, alternating magnetic field changes can be generated, and magnetic lines are cut inside the magnetic gap G to generate a Lorentz force that changes with time to drive the voice coil 24 to move, to enable the diaphragm 21 connected to the voice coil 24 to vibrate synchronously, thereby generating sound waves and transmitting out the sound waves through air from the first sound outlet 12. In some embodiments, the foregoing surround 22 may be made from elastic material such as rubber, polypropylene, or a thermoplastic elastomer. Because the surround 22 has good elasticity and resilience, when the diaphragm 21 vibrates, the surround 22 can generate uniform deformation and stress, so that the diaphragm 21 moves more smoothly, thereby generating better sound quality.

As shown in FIG. 2 and FIG. 4, the bass reinforcement unit 30 corresponds to the second sound outlet 13 of the enclosure 10 and may be fixed in the second cavity 112 in a manner such as a gluing, locking, or clamping manner In this embodiment, the bass reinforcement unit 30 includes a bass reflex tube 31, and the enclosure 10 forms a bass reflex enclosure. The bass reflex tube 31 is an open tube. That is, two ends of the bass reflex tube 31 are not blocked. In addition, one end of the bass reflex tube 31 is located at the second sound outlet 13, and the other end thereof is in communication with the second cavity 112 of the enclosure 10. In some embodiments, the bass reinforcement unit 30 may alternatively be disposed outside the enclosure 10 and in communication with the second cavity 112. No limitation is imposed in this embodiment.

In addition, as shown in FIG. 2 and FIG. 3, the bass reflex tube 31 may output a low-frequency response frequency according to operation of the speaker unit 20, to increase sound pressure of the speaker apparatus 1 in a low-frequency band. For example, a calculation formula of the low-frequency response frequency of the bass reflex tube 31 is

$$f = \frac{e}{2 π} \sqrt{\frac{A}{VL}} ,$$

where f is the low-frequency response frequency, c is the sound velocity (approximately, 343 m/s), A is a cross-sectional area of the bass reflex tube 31, V is the cavity volume of the inner cavity 11 of the enclosure 10, and L is a length of the bass reflex tube 31. In an embodiment, assuming that the cross-sectional area A of the bass reflex tube 31 is 0.636 mm², the length L of the bass reflex tube 31 is 5 mm, and the cavity volume V of the inner cavity 11 is 700 mm³, it can be obtained that the low-frequency response frequency f is 735.7 Hz by substituting them into the foregoing calculation formula. That is, during the operation of the speaker unit 20, the bass reflex tube 31 can generate a low-frequency response frequency f of 735.7 Hz, to increase sound pressure of the speaker apparatus 1 in a low-frequency band around 735.7 Hz.

In another embodiment, as shown in FIG. 5, the bass reinforcement unit 30 may alternatively include a passive radiator 32. Herein, the passive radiator 32 and the speaker unit 20 are respectively disposed on two opposite sides of the inner cavity 11. The passive radiator 32 includes a driven diaphragm 33. When the speaker apparatus 1 operates to enable the diaphragm 21 to vibrate and make sound, the driven diaphragm 33 can generate low-frequency resonance through air, so as to generate a low-frequency response frequency to increase sound pressure of the speaker apparatus 1 in a low-frequency band.

As shown in FIG. 4, the speaker unit 20 has a speaker acoustic compliance value Cas and an effective sound outlet area S. The speaker acoustic compliance value Cas is a product of a mechanical compliance value Cms of the surround 22 and an effective sound outlet area S squared. That is, a calculation formula of the speaker acoustic compliance value Cas is Cas=Cms×S², where Cms is the mechanical compliance value of the surround 22, and S is the effective sound outlet area. The effective sound outlet area S is proportional to an area of the diaphragm 21 or an aperture of the speaker unit 20. In other words, a larger area of the diaphragm 21 or a larger aperture of the speaker unit 20 indicates a larger effective sound outlet area S. The mechanical compliance value Cms of the surround 22 represents compliance of the surround 22. For example, when the mechanical compliance value Cms is larger, it represents that compliance of the surround 22 is higher (stiffness is lower), and when the mechanical compliance value Cms is less, it represents that compliance of the surround 22 is lower (stiffness is higher). It can be learned from the foregoing calculation formula that the speaker acoustic compliance value Cas and the mechanical compliance value Cms of the surround 22 are positively correlated to each other. In other words, a smaller mechanical compliance value Cms of the surround 22 indicates a smaller speaker acoustic compliance value Cas.

In addition, in the speaker apparatus 1 of this embodiment of the instant disclosure, a ratio of the speaker acoustic compliance value Cas of the speaker unit 20 to the cavity acoustic compliance value Cab of the enclosure 10 is adjusted to be less than or equal to 1 (that is, Cas/Cab□ 1), so as to ensure that the bass reinforcement unit 30 can increase sound pressure in a low-frequency band and reinforce output performance of the speaker apparatus when the bass reinforcement unit 30 is applied to an enclosure 10 having a relatively small inner cavity 11 (for example, an inner cavity 11 whose cavity volume V is in a range of 0.5 milliliter to 1 milliliter).

Specifically, because cavity volumes V of the speaker apparatuses 1 applied to a thin or small electronic product having a relatively small inner space are all quite small (most in a range of 0.5 milliliter to 1 milliliter), the cavity acoustic compliance value Cab is also decreased (because Cab=V/ρc²). Therefore, in an embodiment of the instant disclosure, the mechanical compliance value Cms of the surround 22 is decreased to decrease the speaker acoustic compliance value Cas of the speaker unit 20 (because Cas=Cms×S²), to enable the speaker acoustic compliance value Cas to be less than or equal to the cavity acoustic compliance value Cab, thereby adjusting the ratio of the speaker acoustic compliance value Cas to the cavity acoustic compliance value Cab to be less than or equal to 1.

In an embodiment, the mechanical compliance value Cms of the surround 22 may be adjusted to be in a range of 0.12 mm/N to 1.2 mm/N. For example, the mechanical compliance value Cms is decreased by adjusting an appearance structure or material of the surround 22. For example, the surround 22 may be made from material having relatively high rigidity to improve stiffness of the surround 22, so as to decrease the mechanical compliance value Cms by decreasing compliance of the surround 22. Alternatively, in another embodiment, wrinkles may be added to the surround 22, or thickness of the surround 22 may be increased, to improve stiffness of the surround 22 and decrease the mechanical compliance value Cms of the surround 22. For example, as shown in Table 1 below, in this embodiment, the cavity volume V of the inner cavity 11 is 0.7 milliliter, the mechanical compliance value Cms of the surround 22 is adjusted to 0.75 mm/N, and the effective sound outlet area S of the speaker unit 20 is 81 mm². The foregoing values are substituted into the calculation formula (Cab=V/ρc²) of the cavity acoustic compliance value Cab and the calculation formula (Cas=Cms×S²) of the speaker acoustic compliance value Cas, and a ratio of the speaker acoustic compliance value Cas to the cavity acoustic compliance value Cab is calculated, so that a ratio of approximately 0.98 is obtained.

TABLE 1

| Parameter | Value | Unit |
|---|---|---|
| Cms | 0.75 | mm/N |
| S | 81 | mm² |
| V | 0.7 | cc |
| ρ | 1.29 | kg/m³ |
| c | 343 | m/s |
| M | 88 | mg |
| F_{c}(Fₕ) | 872.6 | Hz |

FIG. 6 is a diagram of a sound pressure-frequency curve of the speaker apparatus 1 obtained by carrying out actual tests after the ratio of the speaker acoustic compliance value Cas of the speaker unit 20 to the cavity acoustic compliance value Cab of the enclosure 10 is adjusted to be less than or equal to 1 in this embodiment of the instant disclosure. It can be learned from the present figure that a horizontal axis represents a frequency (Hz), and a longitudinal axis on the left side represents sound pressure (dB), where a curve C1 represents a sound pressure-frequency curve generated by an enclosed enclosure used in the past, and curves C2 to C4 represent sound pressure-frequency curves that are generated by the speaker apparatus 1 in this embodiment of the instant disclosure (where the cavity volume V of the inner cavity 11 of the enclosure 10 is in a range of 0.5 milliliter to 1 milliliter, and the ratio of the speaker acoustic compliance value Cas to the cavity acoustic compliance value Cab is adjusted to be less than or equal to 1). The curve C2 shows an example in which the length L of the bass reflex tube 31 is 4 mm, the curve C3 shows an example in which the length L of the bass reflex tube 31 is 6 mm, and the curve C4 shows an example in which the length L of the bass reflex tube 31 is 10 mm. It can be obviously learned by comparing the curves C1 to C4 that: in this embodiment of the instant disclosure, after the ratio of the speaker acoustic compliance value Cas to the cavity acoustic compliance value Cab is adjusted to be less than or equal to 1, even in a speaker apparatus 1 having a relatively small enclosure 10, the bass reinforcement unit 30 can smoothly increase sound pressure in a low-frequency band. For example, in this figure, sound pressures of the curves C2 to C4 in a range of approximately 400 Hz to 700 Hz are obviously higher than a sound pressure of the curve C1.

Because reducing the mechanical compliance value Cms of the surround 22 would increase a resonant frequency F_{c}(Fₕ) of the speaker unit 20, in this embodiment of the instant disclosure, decreasing a resonant frequency of the speaker unit 20 to keep it in a predetermined range can be achieved by increasing a vibration mass M of the speaker unit 20, for example, adjusting the vibration mass M by making the vibration mass M inversely proportional to the mechanical compliance value Cms. That is, when the mechanical compliance value Cms is adjusted to be smaller, the vibration mass M is adjusted to be larger. In an embodiment, the vibration mass M is total mass of at least one vibration member (such as the diaphragm 21, the surround 22, or the voice coil 24) inside the speaker unit 20 during operation of the speaker unit 20.

Further, a relational formula of the resonant frequency F_{c}(Fₕ), the mechanical compliance value Cms, and the vibration mass M of the speaker unit 20 is

$${F}_{c} ( {F}_{h} ) = \frac{1}{2 π} \frac{1}{\sqrt{{MC}_{AT}}} ,$$

where F_{c}(Fₕ) is the resonant frequency of the speaker unit 20, M is the vibration mass thereof, and CAT is speaker system acoustic total compliance. In addition, a relational formula of the speaker system acoustic total compliance C_{AT}, the speaker acoustic compliance value Cas, and the cavity acoustic compliance value Cab is

$$\frac{1}{{C}_{AT}} = \frac{1}{Cas} + \frac{1}{Cab} .$$

It can be learned from the foregoing relational formula that when the mechanical compliance value Cms is adjusted to be smaller, the speaker acoustic compliance value Cas and the speaker system acoustic total compliance C_{AT} are smaller, so that the resonant frequency F_{c}(Fₕ) of the speaker unit 20 is improved. Therefore, the vibration mass M of the speaker unit 20 may be increased, for example, a weight of the voice coil 24 or the diaphragm 21 may be increased to increase the vibration mass M, so as to decrease the resonant frequency F_{c}(Fₕ) of the speaker unit 20 into a predetermined resonant frequency range.

As shown in Table 1 above, in an embodiment of the instant disclosure, assuming that the predetermined resonant frequency range of the speaker unit 20 is a range of 870 Hz to 875 Hz, when the mechanical compliance value Cms of the surround 22 is adjusted to 0.75 mm/N to make a ratio of the speaker acoustic compliance value Cas to the cavity acoustic compliance value Cab be 0.98, the vibration mass M of the speaker unit 20 may be adjusted and increased to 88 mg, so as to make the resonant frequency F_{c}(Fₕ) of the speaker unit 20 be 872.6 Hz and be kept in the predetermined resonant frequency range.

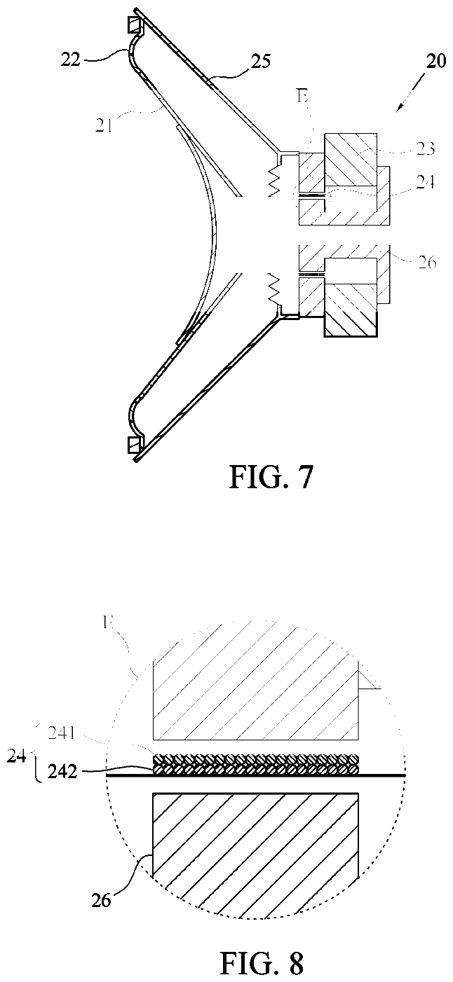

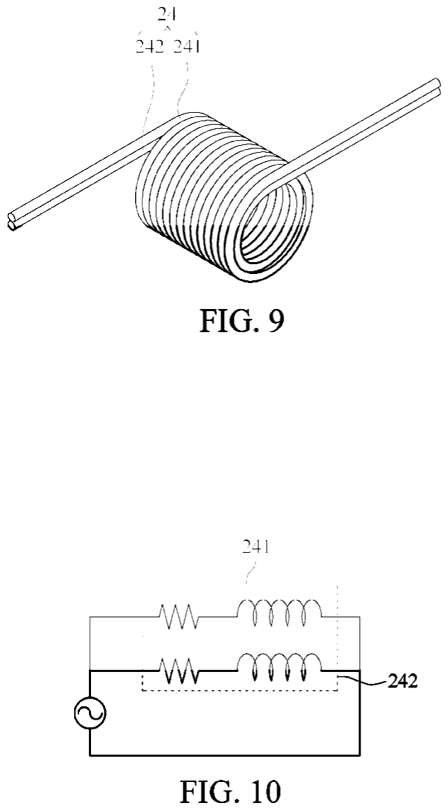

Further, increasing the vibration mass M of the speaker unit 20 would slightly lower the sound pressure output by the speaker unit 20. Accordingly, as shown in FIG. 7 and FIG. 8, FIG. 8 is a partially enlarged diagram of area E in FIG. 7. In this embodiment, the voice coil 24 is divided into two coils (such as a first coil 241 and a second coil 242 in the figure), where a quantity of turns of the first coil 241 may be the same or different from a quantity of turns of the second coil 242. In addition, in this embodiment, the first coil 241 and the second coil 242 are connected to each other in parallel. For details, refer to FIG. 9 and FIG. 10. In this embodiment, the first coil 241 is disposed outside the second coil 242 in a surrounding manner, and the first coil 241 and the second coil 242 are separately electrically connected to a power supply to achieve a parallel connection form. However, the foregoing embodiment is merely an example. In another embodiment, the first coil 241 and the second coil 242 may alternatively interweave with each other (for example, be disposed to be staggered with each other or be disposed to be twisted with each other). A figure of this embodiment is omitted.

Hence, in this embodiment of the instant disclosure, the voice coil 24 is divided into the first coil 241 and the second coil 242 that are connected in parallel to each other, so that a total resistance value of the voice coil 24 can be decreased, and an increased force factor can be achieved, so as to increase sound pressure output by the speaker apparatus 1. Specifically, a relational formula of the force factor and the Lorentz force is F=iBL, where F is a Lorentz force, i is a current, B is magnetic field strength, L is a total length of the voice coil 24, and the force factor is a product of the magnetic field strength B and the total length L of the voice coil 24. Therefore, when the speaker apparatus 1 operates, the Lorentz force generated by a magnetic effect of the current is a product of the current i and the force factor BL. Hence, when the force factor or the current i is larger, a larger Lorentz force can be generated, so that sound pressure output by the speaker apparatus 1 can be increased.

For example, referring to Table 2 below and FIG. 10, the voice coil 24 is divided into the first coil 241 and the second coil 242 that are connected in parallel to each other, so that compared with a non-parallel connection manner of a conventional voice coil 24, a total resistance value (R total) of the voice coil 24 can be greatly reduced while the total current value and the force factor are relatively improved, so as to increase sound pressure output by the speaker apparatus 1. In some embodiments, the voice coil 24 may be alternatively divided into more than two coils that are connected in parallel to each other, further reducing the total resistance value of the voice coil 24 while increasing sound pressure.

In some embodiments, a ratio of a quantity of turns of the voice coil 24 to a cross-sectional area of the coil may be adjusted to generate a proper force factor. For example, as shown in Table 2 below, in a fixed winding space, when a quantity of turns of the voice coil 24 is larger, a cross-sectional area of the voice coil 24 may be adjusted to be smaller. That is, adjustment is performed in a manner in which a quantity of turns of the voice coil 24 is inversely proportional to a cross-sectional area of the coil, so that in a fixed winding space, an optimal resistance value and an optimal coil length can be generated by adjustment, so as to obtain an optimal Lorentz force, to be adapted to different requirements of products or functions.

TABLE 2

| | | Voice coil not in | Voice coil in parallel |
|---|---|---|---|
| | | parallel connection | connection |
| Quantity of turns | | 38 | 60 |
| Voice coil | | 0.035 | 0.028 |
| radius (mm) | | | |
| Cross-sectional area (mm²) | | 0.004 | 0.002 |
| Resistance (Ω) | R2 | | 8.038 |
| | R1 | | 8.038 |
| | R total | 6.517 | 4.019 |

| | | |
|---|---|---|
| Force factor (T-m) | 0.701 | 1.107 |

While the instant disclosure has been described by way of example and in terms of the preferred embodiments, it is to be understood that the instant disclosure needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A speaker apparatus, comprising:
an enclosure, comprising an inner cavity, wherein a cavity volume of the inner cavity is in a range of 0.5 milliliter to 1 milliliter, the enclosure has a cavity acoustic compliance value, and the cavity acoustic compliance value is obtained by dividing the cavity volume by a product of air density and a sound velocity squared;
a speaker unit, disposed inside the inner cavity, wherein the speaker unit comprises a diaphragm and a surround, the surround is disposed around the diaphragm in a surrounding manner, the speaker unit has a speaker acoustic compliance value and an effective sound outlet area, and the speaker acoustic compliance value is a product of a mechanical compliance value of the surround and the effective sound outlet area squared, wherein the effective sound outlet area is proportional to an area of the diaphragm, and a ratio of the speaker acoustic compliance value to the cavity acoustic compliance value is less than or equal to 1; and
a bass reinforcement unit, in communication with the inner cavity, wherein the bass reinforcement unit outputs a low-frequency response frequency according to operation of the speaker unit.

2. The speaker apparatus according to claim 1, wherein the inner cavity comprises a first cavity and a second cavity, the first cavity has a first sound outlet, the second cavity has a second sound outlet, the speaker unit corresponds to the first sound outlet, the bass reinforcement unit comprises a bass reflex tube, and the bass reflex tube corresponds to the second sound outlet.

3. The speaker apparatus according to claim 1, wherein the bass reinforcement unit comprises a passive radiator, the passive radiator comprises a driven diaphragm, and the driven diaphragm vibrates in response to the operation of the speaker unit.

4. The speaker apparatus according to claim 1, wherein the mechanical compliance value of the surround is in a range of 0.12 mm/N to 1.2 mm/N.

5. The speaker apparatus according to claim 1, wherein the speaker unit further has a vibration mass, wherein the vibration mass is total mass of at least one vibration member inside the speaker unit, and the vibration mass is inversely proportional to the mechanical compliance value of the surround, to keep the speaker unit in a resonant frequency range.

6. The speaker apparatus according to claim 5, wherein the at least one vibration member comprises the diaphragm and the surround.

7. The speaker apparatus according to claim 1, wherein the speaker unit comprises a magnetic body and a voice coil, the voice coil is disposed adjacent to the magnetic body and comprises a first coil and a second coil, and the first coil and the second coil are connected in parallel to each other.

8. The speaker apparatus according to claim 7, wherein a quantity of turns of the voice coil is inversely proportional to a coil cross-sectional area.

9. The speaker apparatus according to claim 7, wherein the first coil is disposed outside the second coil in a surrounding manner.

10. The speaker apparatus according to claim 7, wherein the first coil and the second coil interweave with each other.
